(19) United States
(12) Patent Application Publication
(10) Pub. No.: US 2012/0162262 A1
(43) Pub. Date: Jun. 28, 2012

(54) INFORMATION PROCESSOR, INFORMATION PROCESSING METHOD, AND COMPUTER PROGRAM PRODUCT

(75) Inventors: Yuuji IRIMOTO, Tokyo (JP); Kyohei MATSUDA, Tokyo (JP); Yoji NAGAO, Tokyo (JP)

(73) Assignee: KABUSHIKI KAISHA TOSHIBA, Tokyo (JP)

(21) Appl. No.: 13/216,906

(22) Filed: Aug. 24, 2011

(30) Foreign Application Priority Data
Dec. 27, 2010 (JP) 2010-290764

(51) Int. Cl. G09G 5/00

(52) U.S. Cl. 345/650; 345/156

(57) ABSTRACT

According to one embodiment, an information processor includes a display module, an acceleration detector, a knocking operation detector, a specifying module, and a processing module. The display module displays information. The acceleration detector detects acceleration generated in the information processor. The knocking operation detector detects that a knocking operation is performed on the information processor based on a detection result of the acceleration detector. The specifying module specifies, among sides of a graphical user interface (GUI) displayed on the display screen of the display module, a side on which the knocking operation detected by the knocking operation detector is performed. The processing module performs a process associated in advance with the side of the GUI specified by the specifying module.

### CROSS-REFERENCE TO RELATED APPLICATIONS

This application is based upon and claims the benefit of priority from Japanese Patent Application No. 2010-290764, filed Dec. 27, 2010, the entire contents of which are incorporated herein by reference.

### FIELD

Embodiments described herein relate generally to an information processor, an information processing method, and a computer program product.

### BACKGROUND

In recent years, there has been increasing use of information processors such as smart phones and tablet terminals that basically employ touch operation using a touch panel without having an input device such as a keyboard and a mouse. In such information processors, input is provided basically by touch operation on the touch panel. There has been proposed another conventional technology in which an information processor is capable of detecting that the housing is tapped and performing a process associated with the surface of the housing on which this tapping operation is performed.

The information processors described above display graphic use interfaces (GUIs) corresponding to various applications (software) executed on the information processors. Although the touch operation is mainly performed also on the GUIs, the movement amount of a finger increases as the size of the display screen increases, which may cause a load on users. The movement amount of a finger can be reduced by using conventional operating methods in combination. In this case, the operation cannot be performed in units of application (GUI), and thus, there is room for improvement in operability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an appearance of an information processor according to an embodiment;

FIG. 2 is an exemplary block diagram of a hardware configuration of the information processor in the embodiment;

FIG. 3 is an exemplary functional block diagram of the information processor in the embodiment;

FIG. 4A is an exemplary schematic diagram illustrating the operation of the information processor in the embodiment;

FIG. 4B is an exemplary schematic diagram illustrating the operation of the information processor in the embodiment;

FIG. 5A is an exemplary schematic diagram illustrating the operation of the information processor in the embodiment;

FIG. 5B is an exemplary schematic diagram illustrating the operation of the information processor in the embodiment;

FIG. 5C is an exemplary schematic diagram illustrating the operation of the information processor in the embodiment;

FIG. 6A is an exemplary schematic diagram illustrating the operation of the information processor in the embodiment;

FIG. 6B is an exemplary schematic diagram illustrating the operation of the information processor in the embodiment;

FIG. 6C is an exemplary schematic diagram illustrating the operation of the information processor in the embodiment;

FIG. 6D is an exemplary schematic diagram illustrating the operation of the information processor in the embodiment; and

FIG. 7 is an exemplary flowchart of information processing performed by the information processor in the embodiment.

### DETAILED DESCRIPTION

In general, according to one embodiment, an information processor comprises a display module, an acceleration detector, a knocking operation detector, a specifying module, and a processing module. The display module is configured to display information. The acceleration detector is configured to detect acceleration generated in the information processor. The knocking operation detector is configured to detect that a knocking operation is performed on the information processor based on a detection result of the acceleration detector. The specifying module is configured to specify, among sides of a graphical user interface (GUI) displayed on the display screen of the display module, a side on which the knocking operation detected by the knocking operation detector is performed. The processing module is configured to perform a process associated in advance with the side of the GUI specified by the specifying module.

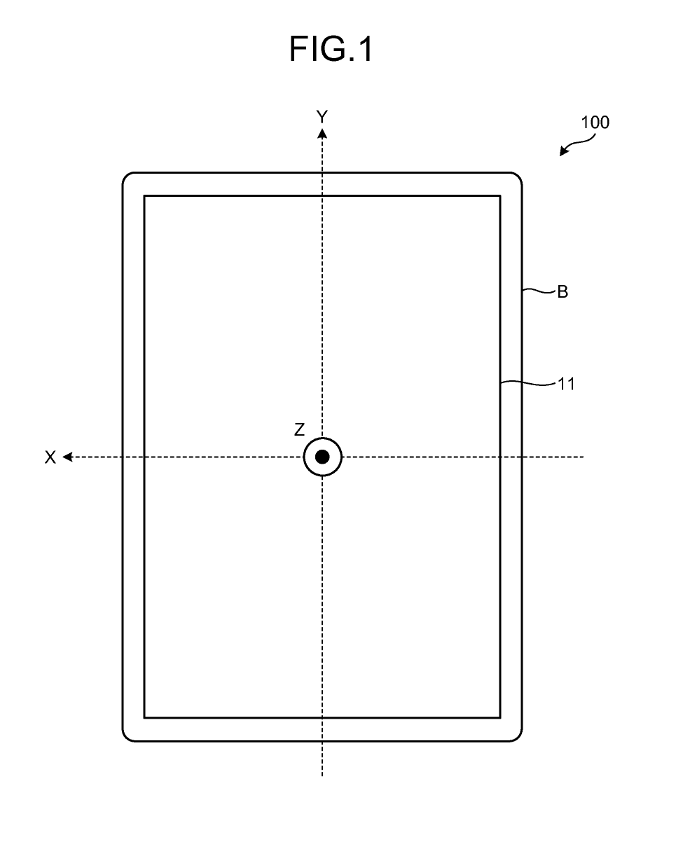

FIG. 1 is a schematic diagram of an appearance of an information processor 100 according to an embodiment. The information processor 100 comprises a display screen and may be, for example, a slate terminal (tablet terminal), an electronic book reader, and a digital photo frame. The directions of the X-axis and the Y-axis indicated by arrows are designated herein as positive directions (the same applies hereinafter).

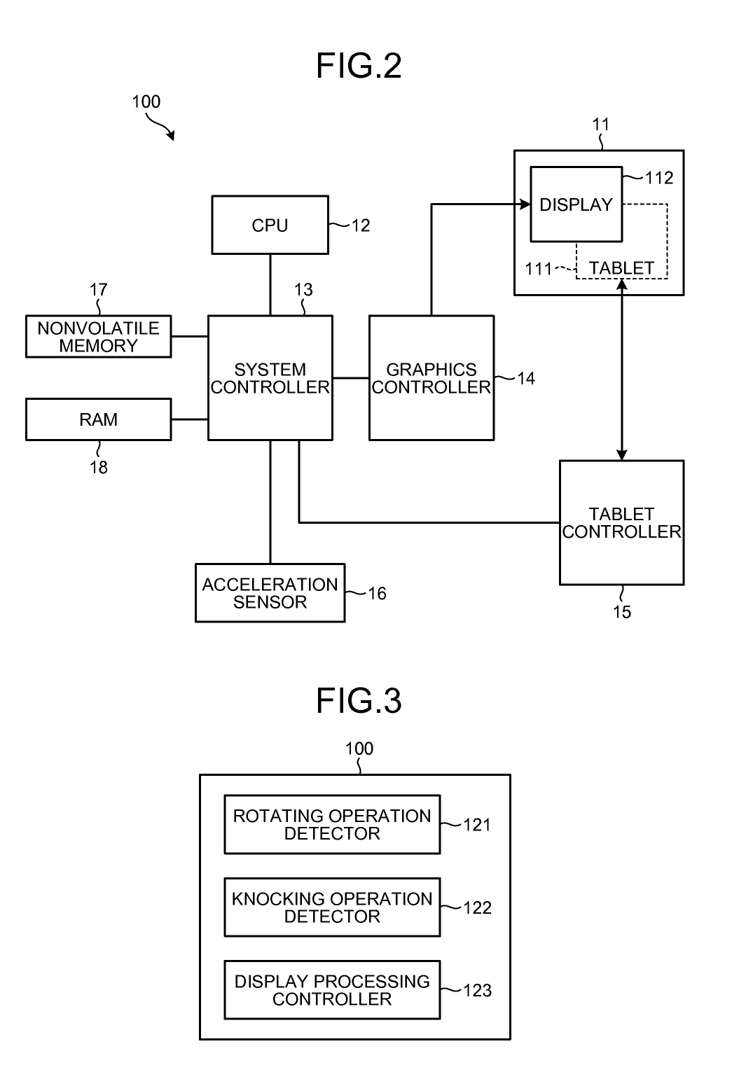

The information processor 100 comprises a thin box-type housing B and a display module 11 on the upper surface of the housing B. The display module 11 comprises a tablet (see a tablet 111 in FIG. 2) that detects a position touched by a user on a display screen. The information processor 100 is not limited to the example of FIG. 1 and may comprise various buttons or switches on the upper surface of the housing B.

FIG. 2 is a block diagram of a hardware configuration of the information processor 100. As illustrated in FIG. 2, the information processor 100 comprises, in addition to the display module 11 described above, a central processing unit (CPU) 12, a system controller 13, a graphics controller 14, a tablet controller 15, an acceleration sensor 16, a nonvolatile memory 17, and a random access memory (RAM) 18.

The display module 11 comprises the tablet 111 and a display 112 such as a liquid crystal display (LCD) and an organic electroluminescent (EL) display. The tablet 111 comprises, for example, a transparent coordinate detector arranged on the display screen of the display 112. As described above, the tablet 111 can detect the position (touch position) touched by a finger of a user on the display screen. The display screen of the display 112 functions as a touch screen by the function of the tablet 111.

The CPU 12 is a processor controlling the operation of the information processor 100 and controls each component of the information processor 100 via the system controller 13. The CPU 12 executes an operating system and various application programs that are loaded from the nonvolatile memory 17 to the RAM 18 and thus implements each functional module described later (see FIG. 3). The RAM 18 functions as a main memory of the information processor 100.

The system controller 13 comprises a built-in memory controller that controls access to the nonvolatile memory 17 and the RAM 18. The system controller 13 also has a function to communicate with the graphics controller 14.

The graphics controller 14 is a display controller that controls the display 112 used as a display monitor of the information processor 100. The tablet controller 15 controls the tablet 111 and obtains coordinate data indicating a position touched by a user on the display screen of the display 112.

The acceleration sensor 16 is, for example, a six-axis acceleration sensor that detects, in addition to three axial directions (X, Y, and Z directions) illustrated in FIG. 1, directions of rotation around the axes. The acceleration sensor 16 detects the direction and the magnitude of acceleration applied from the outside to the information processor 100 and outputs them to the CPU 12. Specifically, the acceleration sensor 16 outputs an acceleration detection signal indicating the axis, direction (rotation angle in the case of rotation), and magnitude of detected acceleration to the CPU 12. The acceleration sensor 16 may be integrated with a gyro sensor for detecting an angular velocity (rotation angle).

FIG. 3 is a functional block diagram of a configuration of the information processor 100. As illustrated in FIG. 3, the information processor 100 cooperates with the CPU 12 and software (the operating system and various application programs) and thereby comprises, as functional modules, a rotating operation detector 121, a knocking operation detector 122, and a display processing controller 123.

The rotating operation detector 121 detects the rotation angle of an operation (hereinafter, “rotating operation”) for rotating the information processor 100 that is performed on the information processor 100 based on an acceleration detection signal output from the acceleration sensor 16.

Specifically, the rotating operation detector 121 determines, if an acceleration detection signal includes a rotation angle around the Z-axis, whether the rotation angle satisfies a predetermined angle condition (for example, 90 degrees or 270 degrees). If the rotation angle satisfies the predetermined angle condition, the rotating operation detector 121 determines that a rotating operation for rotating the information processor 100 is performed and outputs this rotation angle as a rotating operation detection signal to the display processing controller 123. A known technique using integration or the like is used for the detection of a rotation angle. If an acceleration detection signal output from the acceleration sensor 16 includes a rotation angle, this rotation angle may be used.

The knocking operation detector 122 detects an operation (hereinafter, “knocking operation”) for knocking the information processor 100 that is performed on the information processor 100 (housing B) based on an acceleration detection signal output from the acceleration sensor 16.

Specifically, the knocking operation detector 122 determines, if the acceleration detection signal includes acceleration in one direction (positive direction or negative direction) with respect to the X-axis or the Y axis, whether the magnitude of this acceleration exceeds a predetermine threshold. If the magnitude of the acceleration exceeds the threshold, the knocking operation detector 122 determines that the knocking operation is performed on the information processor 100 and outputs the axial direction (for example, an X-axis positive direction) in which the acceleration is generated, as a knocking operation detection signal, to the display processing controller 123.

The display processing controller 123 displays various images corresponding to the operating system and active applications on the display 112. A whole image displayed on the display 112 will be hereinafter referred to as a screen SC. The screen SC comprises, for example, desktop images provided by the operating system and graphical user interfaces (GUIs) such as images provided by various applications. Each of the GUIs is a rectangle (window form), and a process according to the number of knocking operations described later is associated with any of or the whole of the sides (top, bottom, right, and left) of the rectangle. The details of the process associated with each side are not particularly determined.

Upon receipt of a rotating operation detection signal from the rotating operation detector 121, the display processing controller 123 reversely rotates the screen SC by a rotation angle indicated by the rotating operation detection signal. Thus, the display processing controller 123 switches the display so that the direction of the screen SC is constant viewed from a user operating the information processor 100. The display is preferably switched in units of angle (90 degrees) corresponding to the rectangle shape of the display module 11.

Upon receipt of a knocking operation detection signal from the knocking operation detector 122, the display processing controller 123 specifies, among four sides of the screen SC, the side on which the knocking operation is performed based on the rotation angle of the currently displayed screen SC and an axial direction indicated by the knocking operation detection signal. Specifically, the display processing controller 123 determines which of the top and bottom sides of the screen SC and the right and left sides corresponds to which of the X-axis and the Y-axis based on the rotation angle of the currently displayed screen SC, thereby specifying, among these top, bottom, right, and left sides, the side corresponding to the axial direction indicated by the knocking operation detection signal.

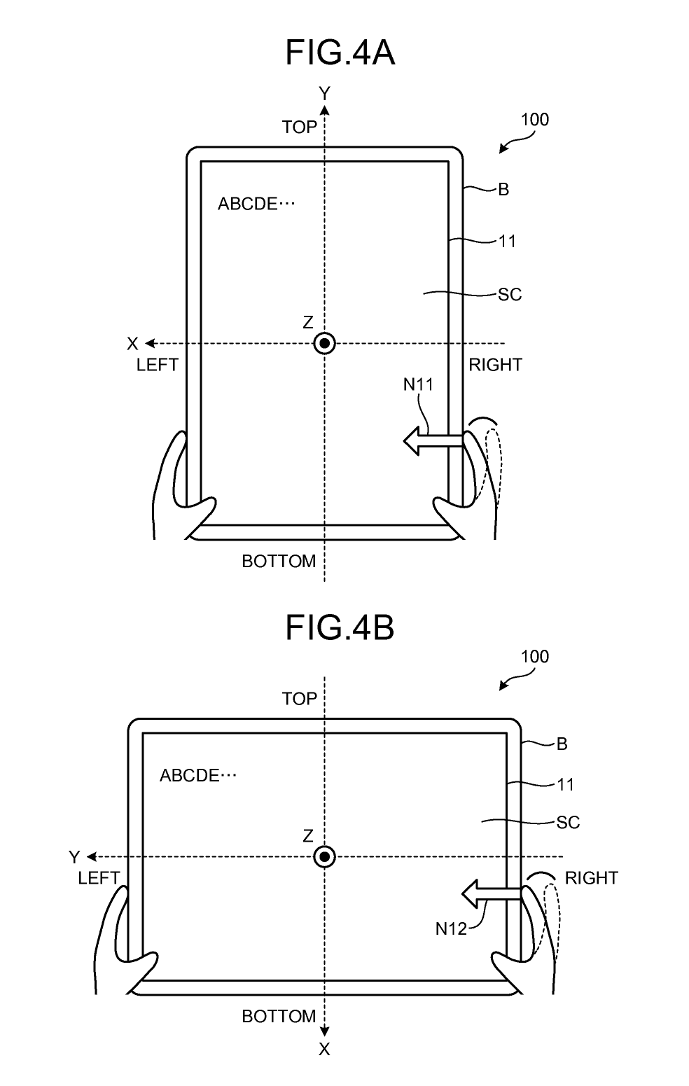

For example, the information processor 100 is rotated 90 degrees to the left around the Z-axis from the state (a rotation angle of 0 degree) illustrated in FIG. 4A, the information processor 100 becomes in the state (a rotation angle of 90 degrees) illustrated in FIG. 4B. During this rotation, the screen SC displayed on the display module 11 is switched depending on the rotation angle of the information processor 100, and therefore, the direction of the screen SC is constant viewed from a user. If a knocking operation is performed from the right of the information processor 100 in the state of a rotation angle of 0 degree or a rotation angle of 90 degrees, the knocking operation detector 122 detects a knocking operation N11 in the X-axis positive direction in the state of a rotation angle of 0 degree and a knocking operation N12 in the Y-axis positive direction in the state of a rotation angle of 90 degrees.

If a knocking operation detection signal is output in the state of a rotation angle of 0 degree, the display processing controller 123 determines that the top and bottom sides of the currently displayed screen SC correspond to the Y-axis direction and the right and left sides correspond to the X-axis direction. The display processing controller 123 determines that the knocking operation is performed from the right side direction of the screen SC based on an axial direction “X-axis positive direction” in the knocking operation detection signal (see FIG. 4A).

On the other hand, if a knocking operation detection signal is output in the state of a rotation angle of 90 degrees, the display processing controller 123 determines that the right and left sides of the currently displayed screen SC correspond to the Y-axis direction and the top and bottom sides correspond to the X-axis direction. Thus, the display processing controller 123 determines that the knocking operation is performed from the right side direction of the screen SC based on an axial direction “Y-axis positive direction” in the knocking operation detection signal (see FIG. 4B).

In such a manner, the display processing controller 123 associates the direction of knocking operation performed on the information processor 100 with the side direction of the screen SC displayed on the display 112. Thus, it is possible to match the top, bottom, right, and left directions of the information processor 100 with the top, bottom, right, and left directions of the screen SC, respectively, viewed from a user.

Referring back to FIG. 3, the display processing controller 123 counts the number of knocking operations performed on the specified side of the screen SC. Specifically, the display processing controller 123 counts the number of knocking operations performed on the same side of the single screen SC within a predetermined period of time (for example, 1 second).

The display processing controller 123 functions as a specifying module that specifies, among the sides of a GUI to be operated, a side corresponding to the side direction of the screen SC which is determined as where knocking operation is performed. The display processing controller 123 also functions as a processing module that performs, among processes associated with the sides of the GUI to be operated, the process corresponding to the number of knocking operations. The GUI to be operated refers to a GUI (active window) displayed at the top.

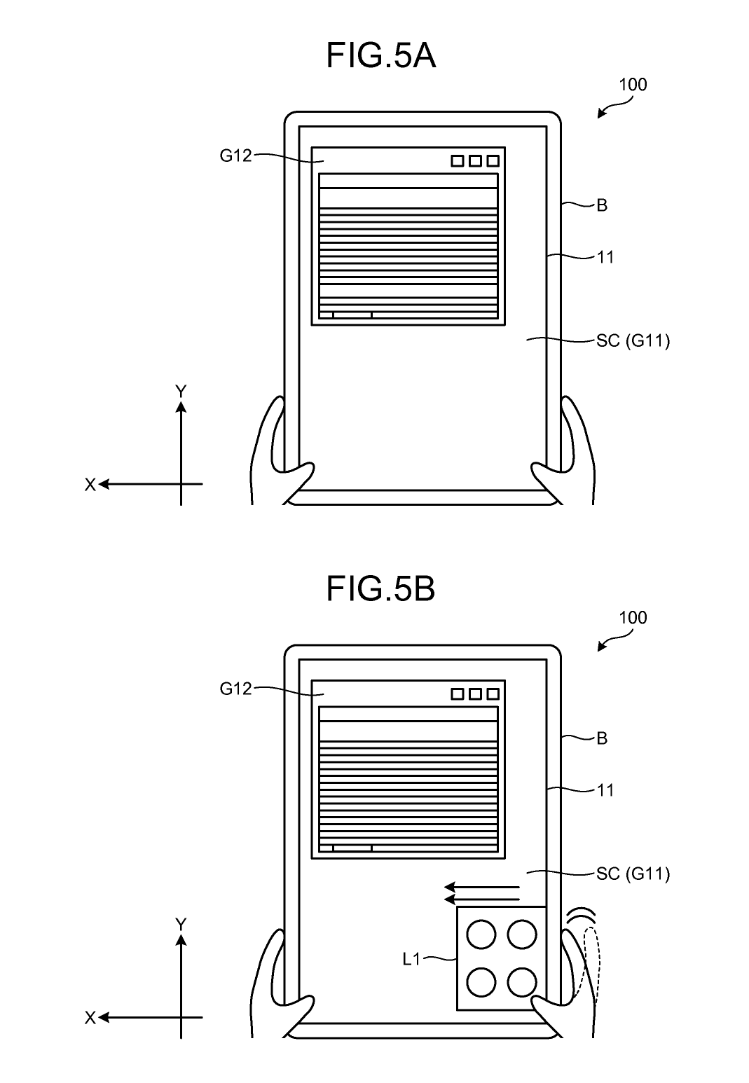

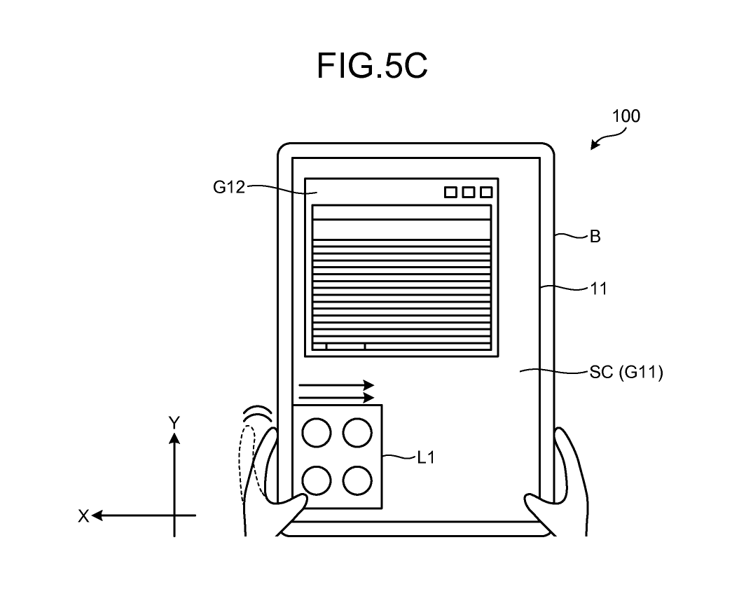

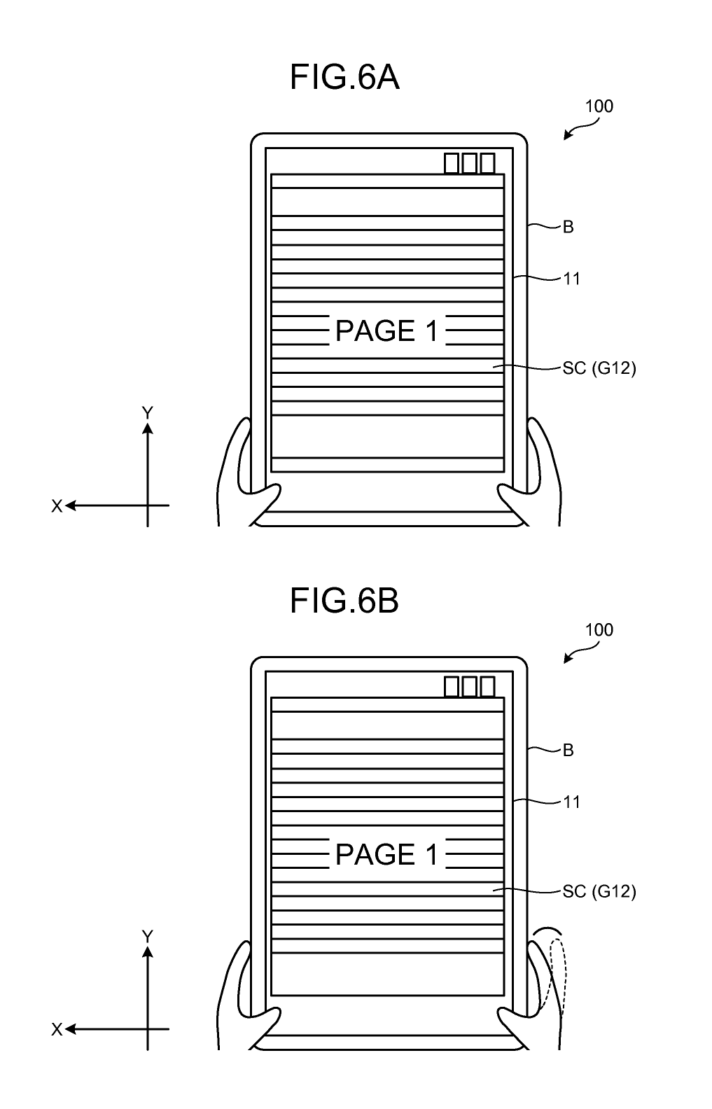

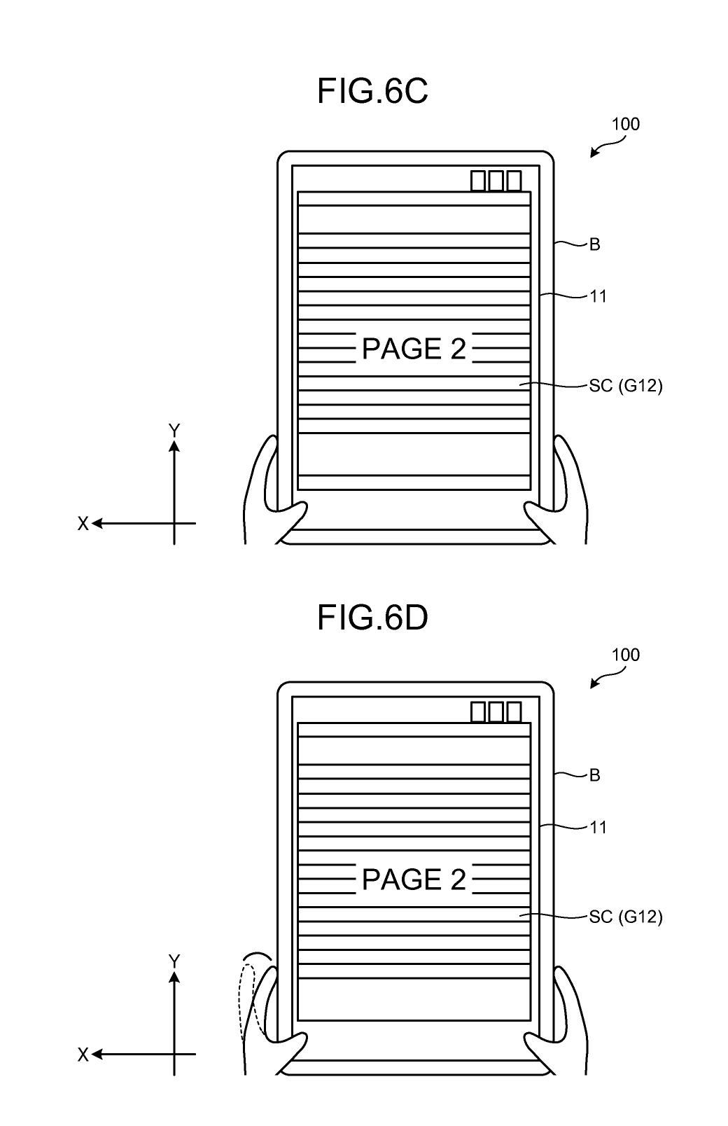

With reference to FIGS. 5A, 5B, and 5C and FIGS. 6A, 6B, 6C, and 6D, a description will be given of the operation of the display processing controller 123 related to knocking operation.

FIG. 5A illustrates an example of a desktop image G11 of a GUI to be operated among GUIs in the screen SC. In FIG. 5A, the right and left sides of the desktop image G11 are associated with the process of displaying a launcher according to a predetermined number (for example, two) of knocking operations. A viewer image G12 on the screen SC is a GUI (hereinafter, “viewer image”) of a document display application, and is not to be operated.

If a predetermined number (two) of knocking operations are performed in the X-axis positive direction (arrow direction) on the information processor 100 in the state illustrated in FIG. 5A, the display processing controller 123 performs a process associated with the right side of the desktop image G11 based on a knocking operation detection signal output from the knocking operation detector 122. As a result, as illustrated in FIG. 5B, the display processing controller 123 displays a launcher L1 in the screen SC (desktop image G11).

If a predetermined number (two) of knocking operations are performed in the X-axis negative direction on the information processor 100 in the state illustrated in FIG. 5A, the display processing controller 123 performs a process associated with the left side of the desktop image G11 based on a knocking operation detection signal output from the knocking operation detector 122. As a result, as illustrated in FIG. 5C, the display processing controller 123 displays the launcher L1 in the screen SC (desktop image G11).

In the examples of FIGS. 5A to 5C, preferably, the launcher L1 appears from the side direction of the screen SC on which the knocking operation is performed and is arranged along the side. With this, a user can make the launcher L1 appear by the intuitive operation, and the launcher L1 can be displayed at a position near the hand performing the knocking operation, which can efficiently lead the user to a touch operation on the launcher L1. The examples of FIGS. 5A to 5C illustrate an example in which the right and left sides of the desktop image G11 are associated with a process of displaying the launcher L1, it is not so limited. For example, other GUIs (for example, a settings panel) may be displayed, or the sides may be associated with different processes by which different types of GUIs are displayed.

FIG. 6A illustrates an example of the viewer image G12 displayed on the entire surface of the screen SC as a GUI to be operated. In FIG. 6A, the right side of the viewer image G12 is associated with a process of turning pages in response to a predetermined number (for example, one) of knocking operations. The left side of the viewer image G12 is associated with a process of returning pages according to a predetermined number (for example, one) of knocking operations.

If a predetermined number (one) of knocking operations are performed in the X-axis positive direction (arrow direction) in the state illustrated in FIG. 6A (see FIG. 6B), the display processing controller 123 performs a process associated with the right side of the viewer image G12 in response to a knocking operation detection signal output from the knocking operation detector 122. As a result, as illustrated in FIG. 6C, the display processing controller 123 turns a page of an electronic book and displays the appropriate page on the viewer image G12.

If a predetermined number (one) of knocking operations is performed in the X-axis negative direction in the state illustrated in FIG. 6C (see FIG. 6D), the display processing controller 123 performs a process associated with the left side of the viewer image G12 based on a knocking operation detection signal output from the knocking operation detector 122. As a result, as illustrated in FIG. 6A, the display processing controller 123 returns a page of the electronic book and displays the appropriate page on the viewer image G12.

In the examples of FIGS. 6A to 6D, the side direction from which pages appear is preferably switched depending on document structures (horizontal writing and vertical writing). For example, in the document of horizontal writing, pages preferably appear from the side direction of the screen SC (viewer image G12) on which knocking operation is performed, and in the document of vertical writing, pages preferably appear from the side direction opposite the side of the screen SC (viewer image G12) on which knocking operation is performed. With this, a user can feed and return pages by the intuitive operation and can visually recognize the feeding and returning of pages. While the FIGS. 6A to 6D illustrate an example in which one page is fed or returned by a single knocking operation, it is not so limited. If a plurality of knocking operations are performed, the number of pages corresponding to the number of knocking operations may be fed or returned.

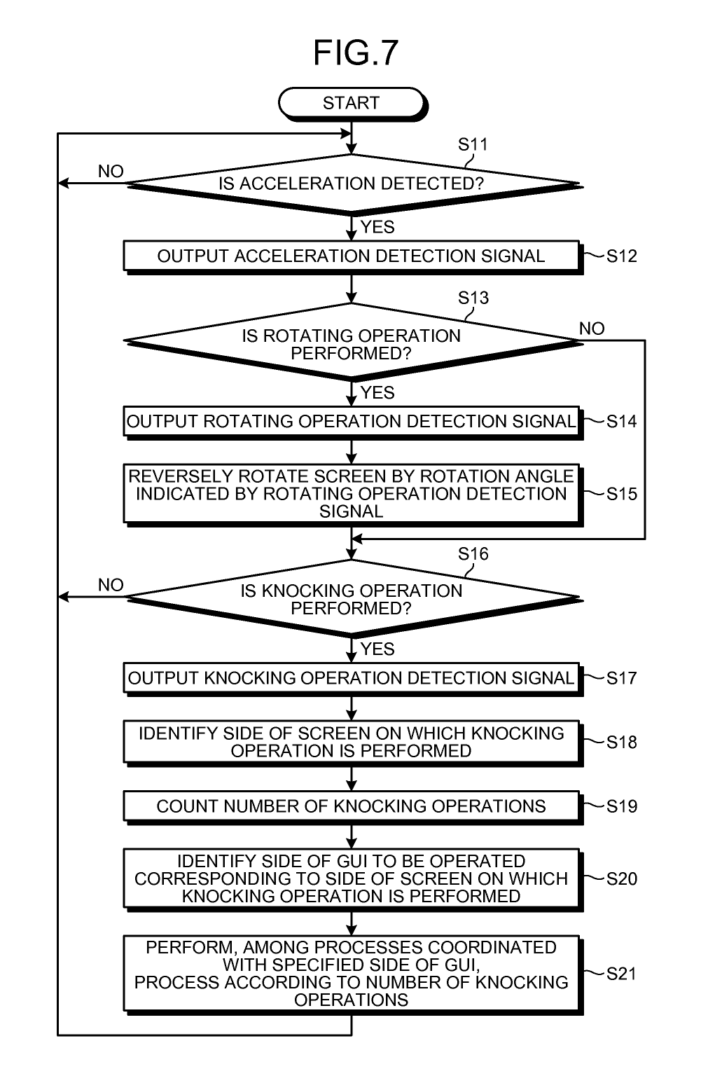

The flow of information processing performed by the information processor 100 will be described below with reference to FIG. 7. FIG. 7 is a flowchart of the information processing performed by the information processor 100.

The acceleration sensor 16 waits until it detects acceleration applied from the outside to the information processor 100 (No at S11). If acceleration is detected (Yes at S11), the acceleration sensor 16 outputs an acceleration detection signal including the direction and magnitude of the acceleration to the CPU 12 (S12).

The rotating operation detector 121 determines whether the acceleration detection signal output from the acceleration sensor 16 contains a rotation angle around the Z-axis and whether the rotation angle satisfies a predetermined angle condition to thereby determines whether a rotating operation is performed (S13). If no condition is satisfied, the rotating operation detector 121 determines that the rotating operation is not performed (No at S13), and the control immediately moves to S16.

If the condition is satisfied at S13, the rotating operation detector 121 determines that the rotating operation is performed (Yes at S13), and outputs the rotation angle as a rotating operation detection signal to the display processing controller 123 (S14). Upon receipt of the rotating operation detection signal from the rotating operation detector 121, the display processing controller 123 reversely rotates the screen SC by a rotation angle indicated by the rotating operation detection signal (S15). Then, the control moves to S16.

The knocking operation detector 122 determines whether the acceleration detection signal output from the acceleration sensor 16 includes acceleration in one direction (positive or negative direction) on the X-axis or the Y axis and whether the magnitude of this acceleration exceeds a predetermine threshold to thereby determine whether a knocking operation is performed (S16). If no condition is satisfied, the knocking operation detector 122 determines that the knocking operation is not performed (No at S16), and the control returns to S11.

If the condition is satisfied at S16, the knocking operation detector 122 determines that the knocking operation is performed (Yes at S16), and outputs the axial direction in which the acceleration is generated, as a knocking operation detection signal, to the display processing controller 123 (S17).

Upon receipt of the knocking operation detection signal from the knocking operation detector 122, the display processing controller 123 specifies the side of the screen SC on which the knocking operation is performed based on the rotation angle of the currently displayed screen SC and the axial direction indicated by the knocking operation detection signal (S18). Subsequently, the display processing controller 123 counts the number of knocking operations performed on the side of the screen SC specified at S18 within a predetermined period of time (S19).

The display processing controller 123 specifies, among the sides of a GUI to be operated, a side corresponding to the side of the screen SC specified at S18 (S20). After that, the display processing controller 123 performs, among processes associated with the side specified at S20, a process according to the number of knocking operations counted at S19 (S21). Then, the control returns to S11.

As described above, according to the embodiment, the information processor 100 can perform a process associated with each side of a GUI displayed on the screen SC (on the display screen) of the display module 11 by knocking operation thereon. Thus, the operability of the information processor 100 can be improved.

Even when the information processor 100 rotates, the side of the GUI corresponding to the direction of knocking operation performed on the information processor 100 can be specified based on the direction of the screen SC displayed according to this rotation. Thus, a process desired by a user can be reliably performed.

In the embodiment described above, the display module 11 comprises a touch screen function, but the embodiment is not limited to this. The display module 11 may also be a typical display device having no touch screen function.

The computer program can be executed on a computer to realize the same function as the information processor 100 of the embodiment described above. The computer program may be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The computer program may also be stored in a computer connected via a network such as the Internet so that it can be downloaded therefrom via the network. Further, the computer program may be provided or distributed via a network such as the Internet.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processor comprising:
a display module configured to display information;
an acceleration detector configured to detect acceleration of the information processor;
a knocking operation detector configured to detect a knocking operation performed on the information processor based on a detection result of the acceleration detector;
a specifying module configured to specify a side among sides of a graphical user interface (GUI) displayed on a display screen of the display module, the side associated with a direction toward which the knocking operation on the information processor is performed, wherein the GUI comprises a target to be operated; and
a processing module configured to perform a process associated with the side from among the sides of the GUI specified by the identification module.

2. The information processor of claim 1, wherein the processing module is further configured to select the process to perform based on a number of knocking operations detected by the knocking operation detector within a period of time.

3. The information processor of claim 1, wherein the specifying module is further configured to specify a location to display a second GUI from a set of GUIs on the display module based on the information processor side on which the knocking operation is performed.

4. The information processor of claim 1, further comprising:
a rotation operation detector configured to detect a rotation angle of a rotation operation performed on the information processor based on the detection result of the acceleration detector; and
a display controller configured to rotate the display screen of the display module according to the rotation angle detected by the rotation operation detector.

5. An information processing method applied to an information processor comprising a display module configured to display information, the information processing method comprising:
detecting, by an acceleration detector, acceleration of the information processor;
detecting, by a knocking operation detector, a knocking operation performed on the information processor based on a detection result of the acceleration detector;
specifying, by a specifying module, a side among sides of a graphical user interface (GUI) displayed on a display screen of the display module, the side associated with a direction toward which the knocking operation on the information processor is performed, the GUI comprising a target to be operated; and
performing, by a processing module, a process associated with the side from among the sides of the GUI.

6. A computer program product embodied on a non-transitory computer-readable storage medium and comprising code that, when executed, causes a computer as an information processor comprising a display module configured to display information to perform a method comprising:
detecting a knocking operation performed on the information processor based on acceleration of the information processor;
specifying a side among sides of a graphical user interface (GUI) displayed on a display screen of the display module, the side associated with a direction toward which the knocking operation on the information processor is performed, the GUI comprising a target to be operated; and
performing a process associated with the side from among the sides of the GUI.

7. The information processor of claim 1, further comprising:
a rotation operation detector configured to detect a rotation angle of a rotation operation performed on the information processor based on the detection result of the acceleration detector, wherein:
the acceleration detector is configured to further detect an axial direction of the information processor in which the acceleration is generated, and
the specifying module is further configured to specify the side based on the axial direction detected by the acceleration detector and the rotation angle detected by the rotation operation detector.

8. The information processor of claim 1, wherein the specifying module is further configured to specify a side direction in which a second GUI is displayed from the sides of the GUI based on a side of the information processor where the knocking operation is performed.

9. The information processor of claim 1, wherein the GUI is displayed in a rectangular shape.
